(19) United States
(12) Patent Application Publication
(10) Pub. No.: US 2026/0241531 A1
(43) Pub. Date: Aug. 20, 2026

(54) HAND-HELD POWER TOOL

(71) Applicant: JIANGSU DONGCHENG TOOLS TECHNOLOGY CO., LTD., NANTONG (CN)

(72) Inventors: Aiguo LIU, NANTONG (CN); Sihao YANG, NANTONG (CN)

(73) Assignee: JIANGSU DONGCHENG TOOLS TECHNOLOGY CO., LTD., NANTONG (CN)

(21) Appl. No.: 18/870,332

(22) PCT Filed: Apr. 11, 2024
(86) PCT No.: PCT/CN2024/087321

§ 371 Date: Nov. 27, 2024

(30) Foreign Application Priority Data
May 30, 2023 (CN) 202310626887.4

(51) Int. Cl. B25F 5/00; B25F 5/02

(52) U.S. Cl. CPC B25F 5/001; B25F 5/02

(57) ABSTRACT

A hand-held power tool includes a housing, a motor assembly and a transmission assembly, a switch assembly, a shift assembly, and an output end. The switch assembly includes a switch element installed on the housing, a trigger configured to trigger the switch element, and a coupling member disposed between the switch element and the trigger. The coupling member includes a connecting portion abutting between the trigger and the switch element and a limiting portion connected to the connecting portion. The shift assembly includes a shift element connected to the transmission assembly, a button configured to move the shift element, a connecting rod connected to the button, and a stop portion installed on the connecting rod. The limiting portion abuts against the stop portion. The switch assembly is a speed adjusting switch and is configured to adjust an output speed of the motor assembly by a pressing stroke of the trigger.

### CROSS REFERENCE TO RELATED APPLICATIONS

The present disclosure is a 35 U.S.C. § 371 National Phase conversion of International (PCT) Patent Application No. PCT/CN 2024/087321, filed on Apr. 11, 2024, which claims priority to Chinese Patent Application No. 202310626887.4, filed on May 30, 2023, the entire disclosures of which are incorporated herein by reference.

### TECHNICAL FIELD

The present disclosure relates to the field of power tools, and in particular to a hand-held power tool used in decoration, construction, and other occasions.

### BACKGROUND

A power tool is a kind of instrument in which a working head is driven by a motor assembly to perform reciprocating motion. In order to convert a high-speed and low-torque force of the motor assembly into a low-speed and high-torque force required by the user, a planetary gear reduction device is usually arranged between the motor assembly and the working head. With a continuous increase of user demands, for hand-held power tools on the market, in particular to straight-shank machine tools, a variable speed device is arranged on the planetary gear reduction device. The user may adjust output speeds of the straight-shank machine tools according to actual use requirements. The variable speed device of the straight-shank machine tool usually has a high-speed gear and a low-speed gear, and the high-speed gear and the low-speed gear may be manually switched by a gear adjustment mechanism.

However, if the planetary gear reduction device in related art is designed to obtain a lower output speed, multi-stage planetary gears are needed for deceleration. This makes the overall volume of the power tool relatively large, which is not conducive to the miniaturization development of the power tool. In addition, based on a theoretical model of planetary gears, a reduction ratio of each stage is 1+Z3/Z1, where Z3 is the number of teeth of an internal ring gear, Z1 is the number of teeth of a sun gear, and a reduction ratio of each stage of planetary gear is not less than 3. When designing the straight-shank machine tools, the traditional planetary gear reduction device is basically unable to achieve a ratio of the high-speed gear to the low-speed gear being less than 3, resulting in the inability to meet diverse operating needs of users.

### SUMMARY OF THE DISCLOSURE

In an aspect, the present disclosure provides a hand-held power tool including a housing, a motor assembly and a transmission assembly both installed on the housing, a switch assembly connected to the motor assembly, a shift assembly connected to the transmission assembly, and an output end driven by the transmission assembly. The switch assembly includes a switch element installed on the housing, a trigger configured to trigger the switch element, and a coupling member disposed between the switch element and the trigger. The coupling member includes a connecting portion abutting between the trigger and the switch element and a limiting portion connected to the connecting portion. The shift assembly includes a shift element connected to the transmission assembly, a button configured to move the shift element, a connecting rod connected to the button, and a stop portion installed on the connecting rod. The limiting portion abuts against the stop portion. The switch assembly is a speed adjusting switch and is configured to adjust an output speed of the motor assembly by a pressing stroke of the trigger.

In another aspect, the present disclosure provides a hand-held power tool including a housing, a motor assembly and a transmission assembly both installed on the housing, a switch assembly connected to the motor assembly, a shift assembly connected to the transmission assembly, and an output end driven by the transmission assembly. The switch assembly includes a switch element installed on the housing, a trigger configured to trigger the switch element, and a coupling member disposed between the switch element and the trigger. The coupling member includes a connecting portion abutting between the trigger and the switch element and a limiting portion connected to the connecting portion. The shift assembly includes a shift element connected to the transmission assembly, a button configured to move the shift element, a connecting rod connected to the button, and a stop portion installed on the connecting rod. The limiting portion abuts against the stop portion. The output end is configured to work in a first state and a second state that operate at different speeds. A speed in the second state is higher than a speed in the first state. A ratio of the speed in the second state to the speed in the first state is less than 3.

In a further aspect, the present disclosure provides a hand-held power tool including a housing, a motor assembly and a transmission assembly both installed on the housing, a switch assembly connected to the motor assembly, and a shift assembly connected to the transmission assembly. The switch assembly includes a switch element installed on the housing, a trigger configured to trigger the switch element, and a coupling member disposed between the switch element and the trigger. The coupling member includes a connecting portion abutting between the trigger and the switch element and a limiting portion connected to the connecting portion. The shift assembly includes a shift element connected to the transmission assembly, a button configured to move the shift element, a connecting rod connected to the button, and a stop portion installed on the connecting rod. The limiting portion abuts against the stop portion. The button simultaneously drives the stop portion and the shift element to move.

### BRIEF DESCRIPTION OF THE DRAWINGS

The embodiments of the present disclosure are further described in detail below in conjunction with the accompanying drawings.

FIG. 1 is a schematic structural view of a hand-held power tool according to some embodiments of the present disclosure.

FIG. 2 is a schematic structural view of the hand-held power tool as shown in FIG. 1 from another view angle according to some embodiments of the present disclosure.

FIG. 3 is a cross-sectional view of the hand-held power tool as shown in FIG. 1 according to some embodiments of the present disclosure, where the hand-held power tool is in a low-speed gear state and a trigger is not pressed.

FIG. 4 is a cross-sectional view of the hand-held power tool as shown in FIG. 1 according to some embodiments of the present disclosure, where the hand-held power tool is in a low-speed gear state and a trigger is pressed to the end.

FIG. 5 is a cross-sectional view of the hand-held power tool as shown in FIG. 1 according to some embodiments of the present disclosure, where the hand-held power tool is in a high-speed gear state and a trigger is not pressed.

FIG. 6 is a cross-sectional view of the hand-held power tool as shown in FIG. 1 according to some embodiments of the present disclosure, where the hand-held power tool is in a high-speed gear state and a trigger is pressed to the end.

FIG. 7 is a schematic structural view of a shift assembly and a switch assembly of the hand-held power tool as shown in FIG. 1 according to some embodiments of the present disclosure.

FIG. 8 is a schematic structural view of the shift assembly and the switch assembly as shown in FIG. 7 from another view angle according to some embodiments of the present disclosure.

FIG. 9 is a schematic structural view of a switch element and a coupling member of a switch assembly of the hand-held power tool as shown in FIG. 1 according to some embodiments of the present disclosure, where a trigger is not pressed.

FIG. 10 is a schematic structural view of the switch element and the coupling member as shown in FIG. 9 according to some embodiments of the present disclosure, where the trigger is pressed but not pressed to a full pressing stroke.

FIG. 11 is a schematic structural view of the switch element and the coupling member as shown in FIG. 9 according to some embodiments of the present disclosure, where the trigger is pressed to a full pressing stroke.

FIG. 12 is a schematic structural view of the coupling member of the switch assembly as shown in FIG. 9 according to some embodiments of the present disclosure.

### DETAILED DESCRIPTION

The present disclosure is described in detail below in conjunction with the accompanying drawings and the embodiments.

The terms used in the present disclosure are for the purpose of describing specific embodiments only and are not intended to limit the present disclosure. For example, the following words indicating the orientation or positional relationship such as “up”, “down”, “front”, “back”, “left”, “right” and etc. are only based on the orientation or positional relationship shown in the drawings, are only for convenience of describing the present disclosure and simplifying the description, and do not indicate or imply that a device/element referred to must have a specific orientation or be constructed and operated in a specific orientation, and therefore cannot be construed as limiting the present disclosure.

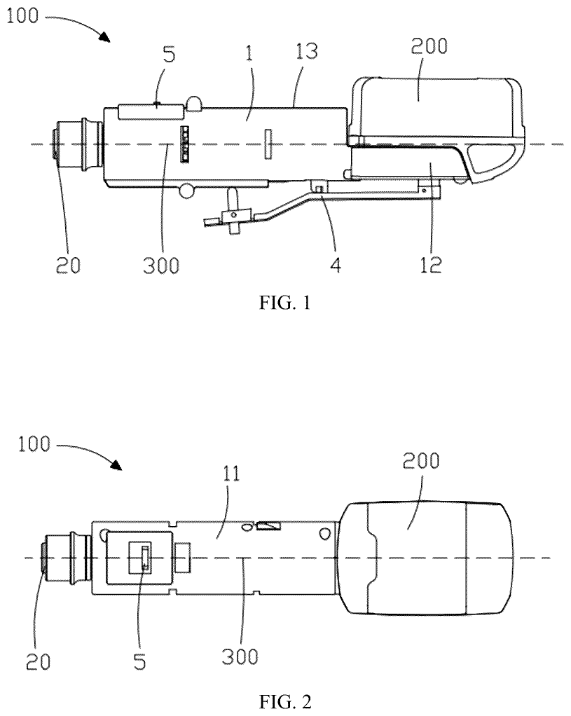

As shown in FIG. 1 to FIG. 3, the embodiments of the present disclosure provide a hand-held power tool being a straight-shank machine tool 100, which is powered by direct current. An end of the straight-shank machine tool 100 is able to be adapted to different kinds of tool head to perform operations such as tightening or loosening screws, drilling holes in walls, inflating tires, polishing and grinding, and etc. The straight-shank machine tool 100 includes a housing 1, a motor assembly 2 and a transmission assembly 3 both installed on the housing 1, a switch assembly 4 connected to the motor assembly 2, a shift assembly 5 connected to the transmission assembly 3, an output end 20 driven by the transmission assembly 3, a control assembly 6 for controlling the motor assembly 2, and a battery pack 200 for providing power to the motor assembly 2. The battery pack 200 is detachably installed on the housing 1, in order to facilitate the battery pack 200 to be charged. In some embodiments, the switch assembly 4 is electrically connected to the control assembly 6. When the user presses the switch assembly 4, the motor assembly 2 is started to rotate, and a force is transmitted to the output end 20 through the transmission assembly 3. By clamping a tool head on the output end 20, operations may be performed on workpieces.

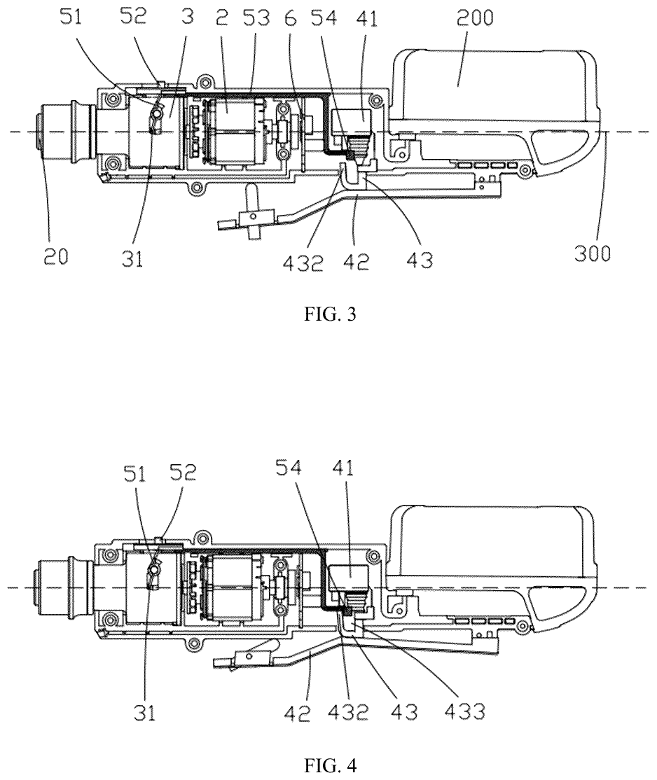

As shown in FIG. 3, the transmission assembly 3 is a planetary gear reduction mechanism 4 and is configured for converting a high-speed and low-torque force output by the motor assembly 2 into a low-speed and high-torque force required by the user. In order to meet the diverse needs of the user, the output end 20 has a first state and a second state running at different speeds. The planetary gear reduction mechanism includes a movable internal ring gear 31. The first state is a low-speed gear state. When in the first state, the internal ring gear 31 participates in a deceleration process, and the output end 20 runs at a low speed. The second state is a high-speed gear state. When in the second state, the internal ring gear 31 is disengaged and does not participate in the deceleration process, and the output end 20 runs at a high speed. The speed in the high-speed gear state is higher than the speed in the low-speed gear state.

In some embodiments, the shift assembly 5 is connected to the internal ring gear 31 of the planetary gear reduction mechanism. When the user moves the shift assembly 5, the internal ring gear 31 may be driven to move, thereby switching between the first state and the second state.

As shown in FIG. 1 and FIG. 2, the housing 1 includes a main portion 11 for accommodating the motor assembly 2 and the transmission assembly 3, and a coupling portion 12 connected to a rear end of the main portion 11. The output end 20 protrudes forwardly to a front end of the main portion 11. An outer periphery of the main portion 11 is formed with a gripping portion 13 for the user to hold. The battery pack 200 is detachably mounted on an upper side of the coupling portion 12. The shift assembly 5 is disposed on an upper side of the main portion 11 and at a position adjacent to the output end 20. The switch assembly 4 is disposed on a lower side of the main portion 11. The control assembly 6 is disposed in the main portion 11 and between the motor assembly 2 and the battery pack 200.

In some embodiments, the gripping portion 13 is located between the shift assembly 5 and the battery pack 200. At least a part of the switch assembly 4 extends to between the shift assembly 5 and the battery pack 200. When the user grasps the gripping portion 13 with the entire palm of the hand, the switch assembly 4 is able to be pressed with the index finger or the middle finger, and the shift assembly 5 is able to be moved forward and backward with the thumb to perform shifting states. Thus, one-handed operation may be achieved and the operation becomes more comfortable and convenient.

In some embodiments, the battery pack 200 is detachably installed on the coupling portion 12. The motor assembly 2 has a first axis 300 extending along a front-rear direction. A plugging direction of the battery pack 200 is approximately the same as an extending direction of the first axis 300.

In some embodiments, a nominal voltage of the battery pack 200 may be greater than or equal to 10 V and less than or equal to 20 V. For example, the nominal voltage of the battery pack 200 may be 12 V, 18 V, 20 V, and etc. In some embodiments, the nominal voltage of the battery pack 200 may be greater than or equal to 20 V and less than or equal to 100 V. For example, the nominal voltage of the battery pack 200 may be 24 V, 40 V, 56 V, 80 V, and etc.

In some embodiments, a number of battery cells contained in a battery cell group of the battery pack 200 may be greater than or equal to 3 and less than or equal to 5. For example, the number of battery cells contained in a battery cell group may be 3, 4, or 5. In some embodiments, the number of battery cells contained in a battery cell group of the battery pack 200 may be greater than or equal to 6 and less than or equal to 25. For example, the number of battery cells contained in a battery cell group may be 6, 10, 14, 20, and etc.

As shown in FIG. 3 and FIG. 4, the switch assembly 4 includes a switch element 41 installed on the housing 1, a trigger 42 configured to trigger the switch element 41, and a coupling member 43 disposed between the switch element 41 and the trigger 42. The trigger 42 is configured to indirectly trigger the switch element 41 through the coupling member 43.

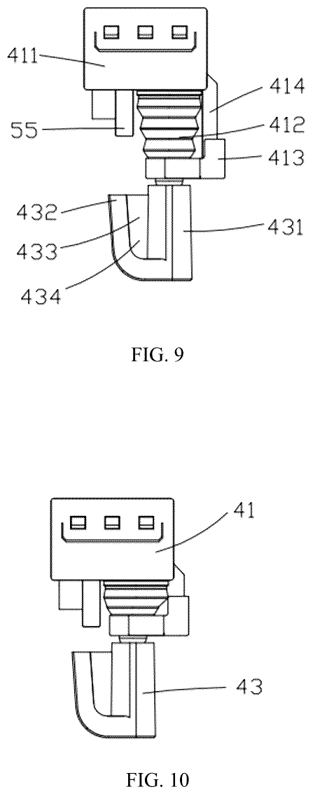

As shown in FIG. 9 to FIG. 11, the switch assembly 4 is a speed adjusting switch and is configured to adjust an output speed of the motor assembly 2 by a pressing stroke of the trigger 42. The output speed of the motor assembly 2 is approximately proportional to the pressing stroke of the trigger 42. In some embodiments, when the user presses the trigger 42 to a full pressing stroke (i.e., presses the trigger 42 to the end), the motor assembly 2 operates at a maximum output speed. When the use presses the trigger 42 to half of the pressing stroke, the motor assembly 2 operates at half of the maximum output speed.

As shown in FIG. 3 to FIG. 6, the shift assembly 5 includes a shift element 51 connected to the internal ring gear 31 of the transmission assembly 3, a button 52 configured to move the shift element 51, a connecting rod 53 connected to the button 52, and a stop portion 54 installed on the connecting rod 53. The button 52 has a first position corresponding to the first state and a second position corresponding to the second state. When the user moves the button 52, the shift element 51 is driven to drive the internal ring gear 31 to move, so as to switch between the first state and the second state.

In some embodiments, an upper end of the button 52 protrudes to the outside of the housing 1 for the user to operate.

In some embodiments, the connecting rod 53 includes a connecting rod main body 531 connected to the button 52, an extending portion 532 configured to install the stop portion 54, and a first sliding portion 533 protruding from a surface of the connecting rod main body 531 towards an inner wall of the housing 1. The connecting rod main body 531 has an L-shape structure and includes a first section 5311 connected to the button 52 and a second section 5312 extending from an end of the first section 5311. The extending portion 532 is connected to an end of the second section 5312. In some embodiments, the connecting rod 53 includes a plurality of first sliding portions 533, and the first sliding portions 533 are spaced apart on the first section 5311. The main portion 11 of the housing 1 includes a support portion 111 configured to support the first section 5311. The support portion 111 has a plurality of second sliding portions similar to the first sliding portions 533. The first sliding portions 533 and the second sliding portions are located on opposite sides of the first section 5311. In some embodiments, the first sliding portions 533 and the second sliding portions are semicircular protrusions. Therefore, the movement of the first section 5311 inside the housing 1 is point contact, making the operations by the user more convenient.

In some embodiments, the connecting rod main body 531, the extending portion 532, the first sliding portions 533, and the stop portion 54 are of an integrated structure.

In some embodiments, the connecting rod 53 and the button 52 are of an integrated structure.

As shown in FIG. 9, the switch element 41 includes a switch body 411 installed on the housing 1, a trigger member 412 movably connected to the switch body 411, a guide pillar 414 fixed to the switch body 411, and a guide member 413 movably connected to the guide pillar 414. The guide member 413 is sleeved on an outer periphery of the guide pillar 414. The trigger member 412 extends through the guide member 413 and is connected to the coupling member 43.

In some embodiments, the trigger 42 drives the coupling member 43 to move, which in turn drives the trigger member 412 and the guide member 413 to move synchronously, thereby activating the switch body 411. The guide member 413 provides guiding function for the movement of the trigger member 412.

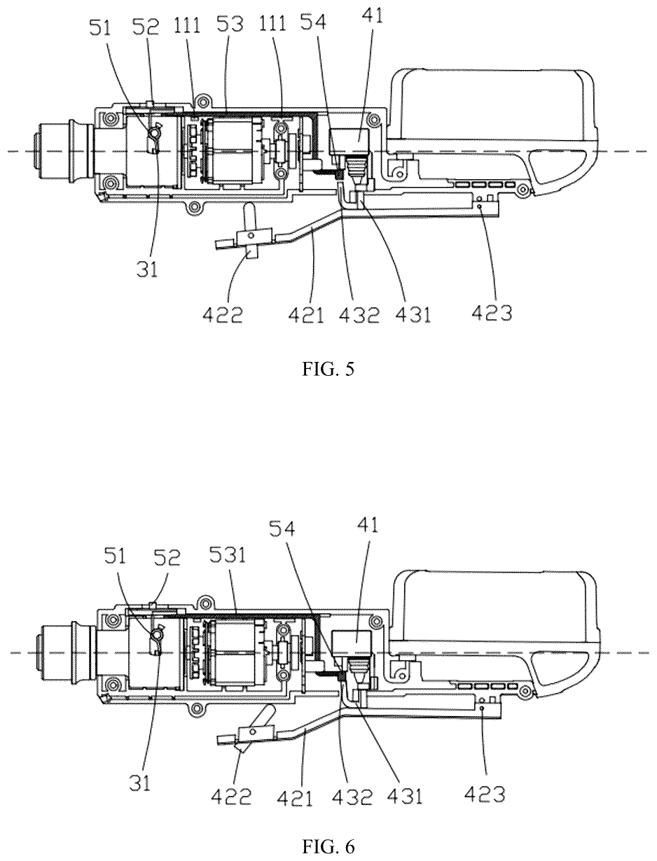

As shown in FIG. 5 and FIG. 6, the trigger 42 is a long-rod trigger and includes a rod body 421 movably connected to the housing 1, a self-locking member 422 rotatably connected to the rod body 421, and a pivot point 423 disposed on the housing 1. The rod body 421 is configured to rotate relative to the housing 1 around the pivot point 423. In some embodiments, the self-locking member 422 has a locked state (as shown in FIG. 5) that limits the movement of the rod body 421 and an unlocked state (as shown in FIG. 6) that does not limit the movement of the rod body 421. The self-locking member 422 may effectively prevent the straight-shank machine tool 100 from being triggered by mistake and ensure the safety of the user during use.

In some embodiments, the rod body 421 abuts against the coupling member 43. When in the unlocked state, if the user presses the rod body 421, the coupling member 43 may be driven to move, thereby triggering the switch element 41.

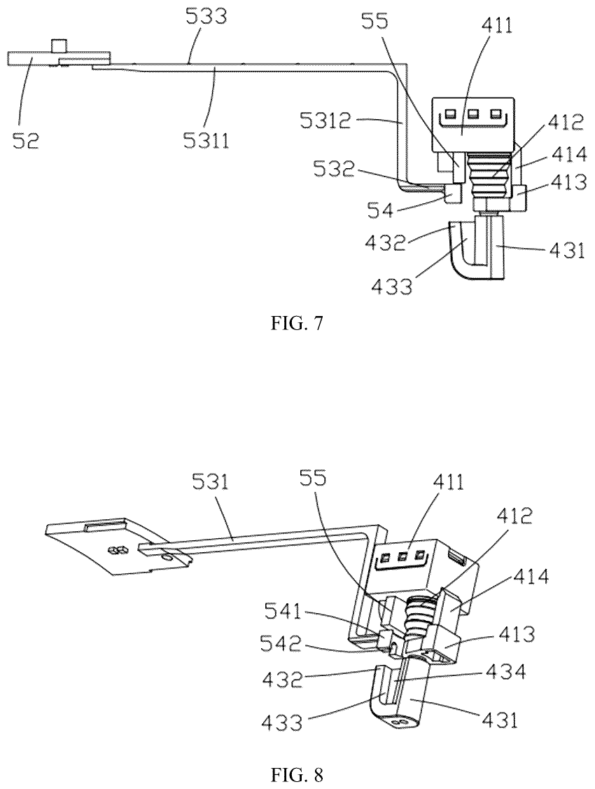

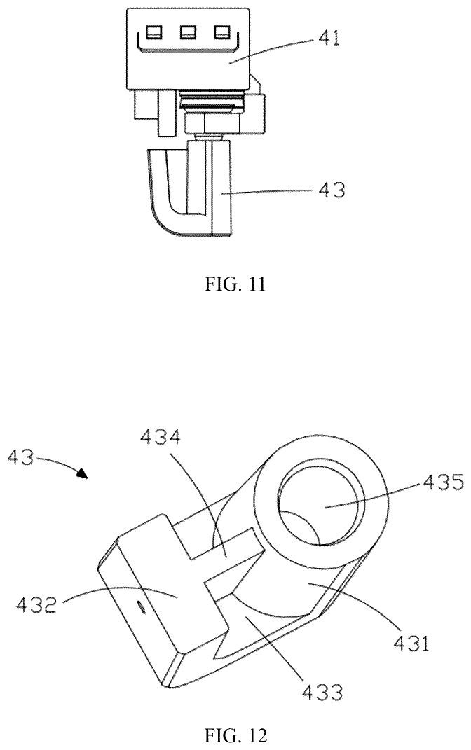

As shown in FIG. 7, FIG. 8 and FIG. 11, the coupling member 43 includes a connecting portion 431 abutting between the trigger 42 and the switch element 41, a limiting portion 432 connected to the connecting portion 431, and a reinforcing rib 434 connected between the connecting portion 431 and the limiting portion 432. An end of the connecting portion 431 abuts against the rod body 421, and the other end of the connecting portion 431 presses against the trigger member 412 to activate the switch body 411. The reinforcing rib 434 helps to increase the service life of the coupling member 43.

As shown in FIG. 12, the connecting portion 431 is defined with a hole 435. The trigger member 412 protrudes and is installed in the hole 435.

In some embodiments, in at least one of the first state and the second state, the stop portion 54 is located on a path of the pressing stroke of the trigger 42. In this way, during the pressing process of the trigger 42, the limiting portion 432 abuts against the stop portion 54, and the trigger 42 may not be pressed to the full pressing stroke (i.e., may not be pressed to the end). Therefore, the maximum output speed of the motor assembly 2 is limited. During actual use, the output end 20 may output a force with a lower speed required by the user to meet the needs of user in different working scenarios.

In some embodiments, in the first state, the limiting portion 432 is not in contact with the stop portion 54, and the trigger 42 is able to be pressed to the full pressing stroke. In the second state, the limiting portion 432 abuts against the stop portion 54, the trigger 42 is unable to be pressed to the full pressing stroke, and the maximum output speed of the motor assembly 2 is limited.

Since the first state is the low-speed gear state and the second state is the high-speed gear state and based on a theoretical model of planetary gears, a reduction ratio of each stage is 1+Z3/Z1, where Z3 is the number of teeth of the internal ring gear and Z1 is the number of teeth of a sun gear, a reduction ratio of each stage of planetary gear is not less than 3, the traditional planetary gear reduction device is basically impossible to achieve a ratio of the speed in the high-speed gear state to the speed in the low-speed gear state being less than 3. In some embodiments, when the user presses the trigger 42 in the high-speed gear state, the limiting portion 432 abuts against the stop portion 54, such that the trigger 42 is unable to be pressed to the full pressing stroke. Therefore, the maximum output speed of the motor assembly 2 is limited. Even in the high-speed gear state, the user may obtain a force with a lower speed, breaking through the limitation that the traditional planetary gear reduction device cannot achieve the ratio of the speed in the high-speed gear state to the speed in the low-speed gear state being less than 3, and effectively meeting the diverse working requirements of the user.

In the embodiments, the speed ratio of the speed in the high-speed gear state to the speed in the low-speed gear state is less than 3.

As shown in FIG. 8 and FIG. 12, the coupling member 43 is defined with an avoiding groove 433 between the connecting portion 431 and the limiting portion 432. The stop portion 54 includes a base body 541 abutting against the limiting portion 432 and a movable groove 542 concaved from a surface of the base body 541. The reinforcing rib 434 is configured to move in the movable groove 542.

In some embodiments, in the first state, the base body 541 of the stop portion 54 extends into the avoiding groove 433, and the reinforcing rib 434 extends into the movable groove 542.

In some embodiments, at least part of the reinforcing rib 434 is located in the avoiding groove 433.

In some embodiments, the button 52 moves forward and backward along the first axis 300 and drives the stop portion 54 to move forward and backward along the first axis 300.

In some embodiments, the button 52 simultaneously drives the stop portion 54 and the shift element 51 to move.

As shown in FIG. 7, the shift assembly 5 also includes a support member 55 configured to support the stop portion 54. The support member 55 and the limiting portion 432 are located at two sides of the stop portion 54 respectively. Since the connecting rod 53 has a certain elasticity, when the limiting portion 432 is pressed against the stop portion 54, the stop portion 54 is pressed against the support member 55. The support member 55 effectively prevents the connecting rod 53 from being excessively deformed, thereby avoiding damage to the connecting rod 53.

In some embodiments, the support member 55 is installed on the switch body 411 and is located at a position adjacent to the trigger member 412.

The present disclosure is not limited to the embodiments described above. Those of ordinary skill in the art may easily understand that, without departing from the principles and scope of the present disclosure, there are many other alternatives solutions for the hand-held power tool of the present disclosure. The protection scope of the present disclosure is determined by the contents of the claims.

1. A hand-held power tool, comprising:
a housing;
a motor assembly and a transmission assembly, both installed on the housing;
a switch assembly, connected to the motor assembly and comprising:
a switch element, installed on the housing;
a trigger, configured to trigger the switch element; and
a coupling member, disposed between the switch element and the trigger, wherein the coupling member comprises:
a connecting portion, abutting between the trigger and the switch element; and
a limiting portion, connected to the connecting portion;
a shift assembly, connected to the transmission assembly, wherein the shift assembly comprises:
a shift element, connected to the transmission assembly;
a button, configured to move the shift element;
a connecting rod, connected to the button; and
a stop portion, installed on the connecting rod, wherein the limiting portion abuts against the stop portion; and
an output end, driven by the transmission assembly;
wherein the switch assembly is a speed adjusting switch and is configured to adjust an output speed of the motor assembly by a pressing stroke of the trigger.

2. The hand-held power tool according to claim 1, wherein the output end has a first state and a second state, which are running at different speeds, the transmission assembly comprises a movable internal ring gear, the button has a first position corresponding to the first state and a second position corresponding to the second state, the shift element is connected to the internal ring gear, and the button is configured to move for switching between the first state and the second state.

3. The hand-held power tool according to claim 2, wherein the first state is a low-speed gear state, the second state is a high-speed gear state, and in at least one of the first state and the second state, the limiting portion abuts against the stop portion.

4. The hand-held power tool according to claim 3, wherein in the first state, the limiting portion is not in contact with the stop portion and the trigger is able to be pressed to the end; in the second state, the limiting portion abuts against the stop portion, the trigger is unable to be pressed to the end, and a maximum output speed of the motor assembly is limited.

5. The hand-held power tool according to claim 4, wherein the coupling member is defined with an avoiding groove between the connecting portion and the limiting portion, and in the first state, the stop portion extends into the avoiding groove.

6. The hand-held power tool according to claim 5, wherein the coupling member comprises a reinforcing rib connected between the connecting portion and the limiting portion, and at least part of the reinforcing rib is located in the avoiding groove.

7. The hand-held power tool according to claim 6, wherein the stop portion comprises a base body abutting against the limiting portion and a movable groove concaved from a surface of the base body, and the reinforcing rib is configured to move in the movable groove.

8. The hand-held power tool according to claim 1, wherein the shift assembly comprises a support member configured to support the stop portion, and the support member and the limiting portion are located at two sides of the stop portion respectively.

9. The hand-held power tool according to claim 1, wherein the switch element comprises a switch body installed on the housing and a trigger member movably connected to the switch body, and the connecting portion is configured to press against the trigger member to activate the switch body.

10. The hand-held power tool according to claim 9, wherein the switch element comprises a guide pillar fixed to the switch body and a guide member movably connected to the guide pillar, and the trigger member extends through the guide member and is connected to the connecting portion.

11. The hand-held power tool according to claim 10, wherein the connecting portion comprises a hole for installing the trigger member, and the trigger member protrudes the hole.

12. The hand-held power tool according to claim 1, wherein the output speed of the motor assembly is approximately proportional to the pressing stroke of the trigger.

13. The hand-held power tool according to claim 1, wherein the connecting rod comprises a connecting rod main body connected to the button, an extending portion configured to install the stop portion, and a first sliding portion protruding from a surface of the connecting rod main body towards an inner wall of the housing;
the connecting rod main body has an L-shape structure and comprises a first section connected to the button and a second section extending from an end of the first section.

14. The hand-held power tool according to claim 13, wherein the connecting rod main body, the extending portion, the first sliding portions, and the stop portion are of an integrated structure.

15. A hand-held power tool, comprising:
a housing;
a motor assembly and a transmission assembly, both installed on the housing;
a switch assembly, connected to the motor assembly and comprising:
a switch element, installed on the housing;
a trigger, configured to trigger the switch element; and
a coupling member, disposed between the switch element and the trigger, wherein the coupling member comprises:
a connecting portion, abutting between the trigger and the switch element; and
a limiting portion, connected to the connecting portion;
a shift assembly, connected to the transmission assembly, wherein the shift assembly comprises:
a shift element, connected to the transmission assembly;
a button, configured to move the shift element;
a connecting rod, connected to the button; and
a stop portion, installed on the connecting rod, wherein the limiting portion abuts against the stop portion; and
an output end, driven by the transmission assembly and configured to work in a first state and a second state that operate at different speeds;
wherein a speed in the second state is higher than a speed in the first state, and a ratio of the speed in the second state to the speed in the first state is less than 3.

16. The hand-held power tool according to claim 15, further comprising a control assembly for controlling the motor assembly and a battery pack for providing power to the motor assembly, wherein the housing comprises a main portion for accommodating the motor assembly and the transmission assembly, and a coupling portion connected to a rear end of the main portion, the output end protrudes forwardly to a front end of the main portion, the battery pack is detachably mounted on an upper side of the coupling portion, and the control assembly is disposed in the main portion and between the motor assembly and the battery pack.

17. The hand-held power tool according to claim 16, wherein the shift assembly is disposed on an upper side of the main portion and at a position adjacent to the output end, and the switch assembly is disposed on a lower side of the main portion.

18. The hand-held power tool according to claim 17, wherein an outer periphery of the main portion is formed with a gripping portion for gripping, the gripping portion is located between the shift assembly and the battery pack, and at least a part of the switch assembly extends to between the shift assembly and the battery pack.

19. A hand-held power tool, comprising:
a housing;
a motor assembly and a transmission assembly, both installed on the housing;
a switch assembly, connected to the motor assembly and comprising:
a switch element, installed on the housing;
a trigger, configured to trigger the switch element; and
a coupling member, disposed between the switch element and the trigger, wherein the coupling member comprises:
a connecting portion, abutting between the trigger and the switch element; and
a limiting portion, connected to the connecting portion;
a shift assembly, connected to the transmission assembly, wherein the shift assembly comprises:
a shift element, connected to the transmission assembly;
a button, configured to move the shift element;
a connecting rod, connected to the button; and
a stop portion, installed on the connecting rod, wherein the limiting portion abuts against the stop portion;
wherein the button simultaneously drives the stop portion and the shift element to move.

20. The hand-held power tool according to claim 19, wherein the motor assembly has a first axis extending along a front-rear direction, the button is configured to move forward and backward along the first axis and simultaneously drive the stop portion and the shift element to move forward and backward along the first axis.
